(19) United States
(12) Patent Application Publication
(10) Pub. No.: US 2006/0014565 A1
(43) Pub. Date: Jan. 19, 2006

(54) Multi-output connector capable of receiving data wirelessly

(76) Inventor: Chien-Tsung Chen, Taipei (TW)

Correspondence Address: Han-Yi Lee;BAYSHORE PATENT GROUP, LLC., 520 Chantecler Dr., Fremont, CA, 94539, US

(21) Appl. No.: 11/075,410

(22) Filed: Jun. 6, 2005

(30) Foreign Application Priority Data
Jul. 19, 2004 (TW) 093211387

(51) Int. Cl. H04M 3/00

(52) U.S. Cl. 455/557

(57) ABSTRACT

The present invention provides a multi-output connector capable of receiving data wirelessly, comprising: a wireless receive circuit, which is placed inside the wireless input device and functions to receive data wirelessly; at least one first output connecting part, which is electrically connected to the wireless receive circuit and functions as a connection path for outputting data; at least one second output connecting part, which is electrically connected to the wireless receive circuit and functions as a connection path for outputting data.

### BACKGROUND OF THE INVENTION

1. Field of the Invention

The present invention relates to a connector, more particularly to a multi-output connector capable of receiving data wirelessly.

2. Description of the Prior Art

As Universal Serial Bus (USB) becomes widely accepted and used, a majority of pluggable electronic devices adopt USB for connection purpose, such as pluggable electronic products with Mouse USB Dongle. FIG. 1A illustrates a known pluggable electronic device with USB 10, such as the Mouse USB Dongle, which possesses a single USB plug and fits perfectly another electronic device equipped with a USB jack. However, when one wants to connect the above known pluggable electronic device 10 to an electronic device with a PS2 jack, but not a USB jack, he needs to employee a converter 20, such as a PS2-USB converter, to make the connection. As shown in FIG. 1B, a converter 20 is connected first to a known pluggable electronic device 10 with its USB plug 20A and then, with its PS2 plug 20B, connected to a PS2 jack on another electronic device. Known converters 20, with their intrinsic converting function, enable a pluggable electronic device 10 to work with non-USB products and to extend its usage. However, these converters bring users problems with their bulky size, of increasing manufacturing cost, and inconvenience in using.

The present invention is made to overcome the above-mentioned problems of the related arts. It is an object of the present invention to provide a multi-output connector capable of receiving data wirelessly. It can directly connect to an electronic device without the need of any converter.

### SUMMARY OF THE INVENTION

The primary objective of the present invention is to provide a multi-output device capable of receiving data wirelessly. It is equipped with various plugs at its output end and capable of connecting to an electronic device without the need of any converter.

To achieve the purpose of this present invention, the present invention provides a multi-output connector capable of receiving data wirelessly comprising a wireless receive circuit, which is placed inside the wireless input device and with function of receiving data wirelessly; at least one “first output connecting part”, which is electrically connected to the wireless receive circuit and functions as a connection path for outputting data; and at least one “second output connecting part”, which is electrically connected to the wireless receive circuit and functions as another connection path for outputting data.

### BRIEF DESCRIPTION OF THE DRAWINGS

The foregoing and other features and advantages of the present invention will be more clearly understood from the following detailed description and the accompanying drawings, in which:

FIG. 1A shows the structure of a known pluggable electronic device with a USB plug;

FIG. 1B shows a converter connected to the known electronic device in FIG. 1A;

FIG. 2 is a perspective view showing the multi-output connector of the present invention;

FIG. 3 illustrates the preferred embodiment of the multi-output connector of the present invention in FIG. 2;

FIG. 4 illustrates another preferred embodiment of the multi-output connector of the present invention in FIG. 2;

FIG. 5 illustrates yet another preferred embodiment of the multi-output connector of the present invention in FIG. 2;

FIG. 6 illustrates an alternative embodiment of the multi-output connector of the present invention in FIG. 2;

FIG. 7 illustrates another alternative embodiment of the multi-output connector of the present invention in FIG. 2 with an input connecting part added.

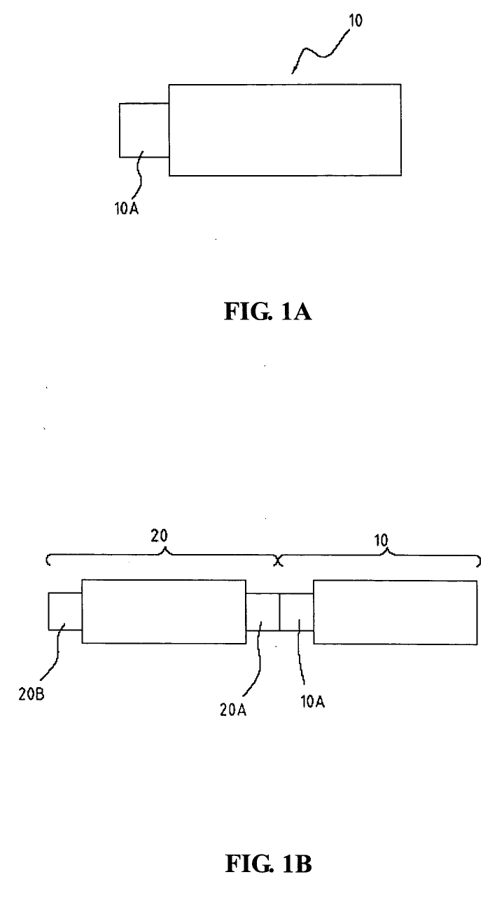

### DETAILED DESCRIPTION OF THE PREFERRED EMBODIMENT

The following description of the preferred embodiments discloses specific configurations, data value, and components. The description of various features and structures of the present invention which would be known to one skilled in the art are omitted for the sake of clarity and brevity.

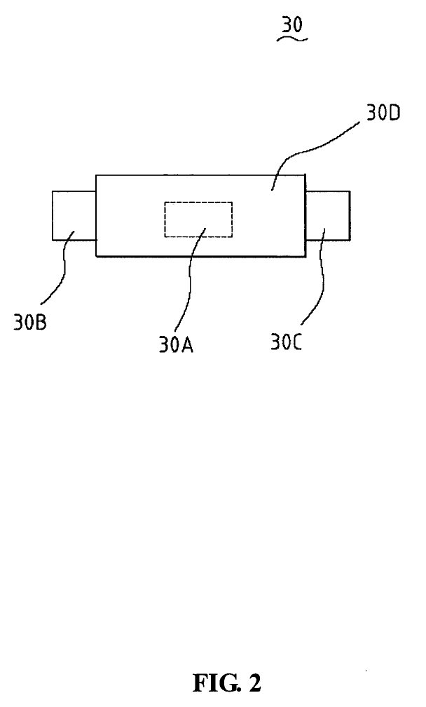

FIG. 2 is a perspective view showing the multi-output connector of the present invention. The multi-output connector 30, through either the first connecting part 30B or the second connecting part 30C, connects with a computer connecting port such as an USB jack or a PS2 jack of a device, for example, a computer. The multi-output connector 30 comprises a wireless receive circuit 30A, at least one first output connecting part 30B, and at least one second connecting part 30C. All are described in more detail below.

The wireless receive circuit 30A is placed inside the wireless input device 30 and functions of wirelessly receiving data sent by a wireless mouse, a wireless keyboard or others. There is usually one first output connecting part 30B; but the amount could be many. The embodiment of the first output connecting part 30B is different from that of the second output connecting part 30C. Also, there is usually one second output connecting part 30C; but its amount could be many. Either the first output connecting part 30B or the second connecting part 30C is actually in contact with a electronic device, such as a computer, and forms a connection path with plugs and jacks. Data are received and transferred to the electronic device through this connection path. One embodiment of this present invention is a microcontroller unit (MCU), code number of MC68HC908JB16 by Motorola, Inc. Furthermore, the two input/output pins: PTE3/D+ and PTE4/D−, already function as both UDB and PS2 interface.

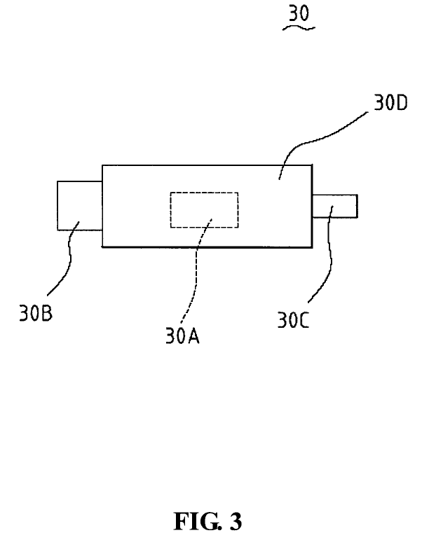

FIG. 3 illustrates the preferred embodiment of the multi-output connector of the present invention in FIG. 2. In FIG. 3, the embodiment of first output connecting part 30B is a single USB connector. The embodiment of second output connecting part 30C is a single PS2 connector. The USB connector and PS2 connector are both directly attached to but placed on opposite sides of the body 30D of the multi-output connector 30.

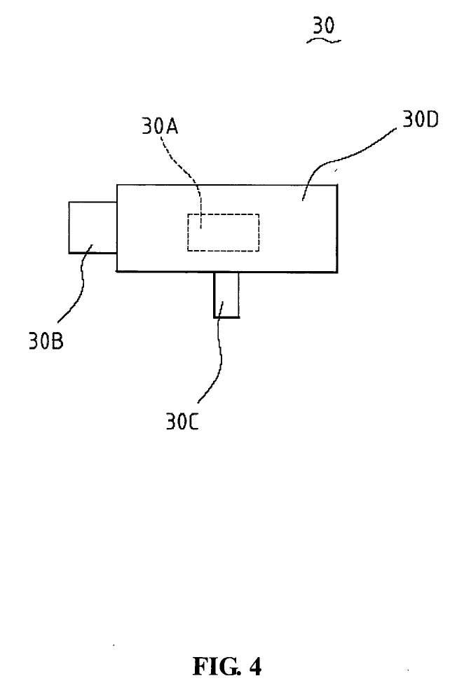

FIG. 4 illustrates another preferred embodiment of the multi-output connector of the present invention in FIG. 2. As shown in FIG. 4, the embodiment of the first output connecting part 30B is a single USB connector. The embodiment of the second output connecting part 30B is a single PS2 connector. The USB connector 30B and the PS2 connector 30C are both directly attached to and placed on adjacent sides of the body 30D of the multi-output connector 30.

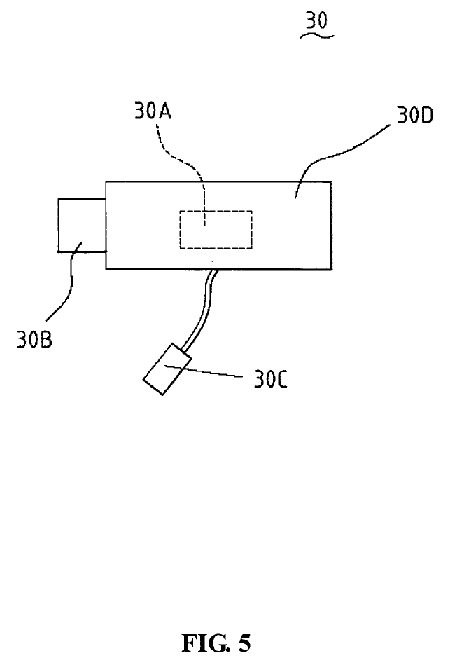

FIG. 5 illustrates yet another preferred embodiment of the multi-output connector of the present invention in FIG. 2. As shown in FIG. 5, the embodiment of the first output connecting part 30B is a single USB connector. The embodiment of the second output connecting part 30B is a single wired PS2 connector. The USB connector 30B and the PS2 connector 30C are placed on adjacent sides of the body 30D of the multi-output connector 30. But only the USB connector 30B is directly attached to the body 30D.

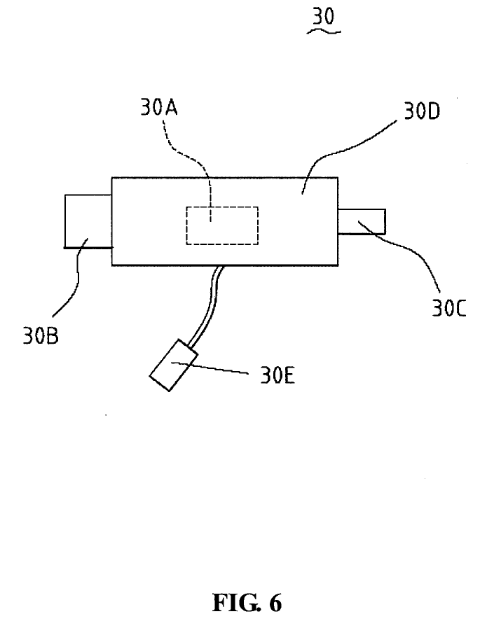

FIG. 6 illustrates an alternative embodiment of the multi-output connector of the present invention in FIG. 2. As shown in FIG. 6, the multi-output connector 30 of the present invention further comprises one or several third output connecting parts 30E. The embodiment of the third output connecting part 30E could be an USB connector or a PS2 connector. The embodiment of the first output connector 30B is a single USB connector. The embodiment of the second output connector 30C is a single wired PS2 connector. The USB connector 30B and wired PS2 connector 30C are attached to and placed on the opposite sides of the body 30D of the multi-output connector 30. The third output connector 30E is a wired PS2 connector and situated yet another side of the body 30D of the multi-output connector 30.

The PS2 connector 30C in FIG. 5 and the PS2 connector 30E in FIG. 6 could individually be replaced with a wired USB connector. Furthermore, the first output connector 30B, the second output connector 30C and the third output connector 30E can also be individually replaced with an IEEE1394 connector or wired IEEE1394 connector.

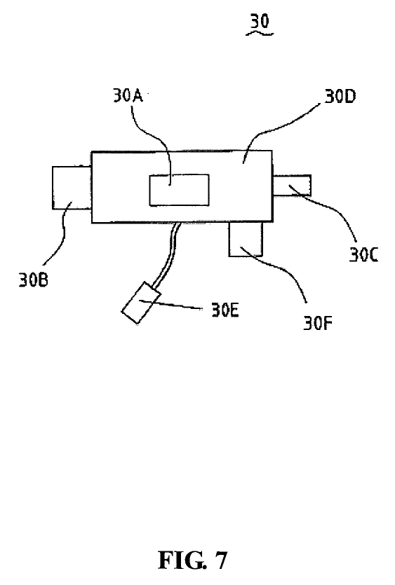

FIG. 7 illustrates yet another alternative embodiment of the multi-output connector of the present invention in FIG. 2. As shown in FIG. 7, the multi-output connector 30 comprises a first output connector 30B, a second output connector 30C, and an input connector 30F, which connects with a wired input device, such as a connecting keyboard, a mouse, a tracking ball, a joystick or others. The embodiment of an input connector 30F could be a USB jack, a PS2 jack or others. Data input with a wired input device would pass through a communication path—first through the input connector 30F, then through either the first output connecting part 30B or the second output connecting part 30C, and arrive an electronic device. Because the input connector 30F connects with a wired input device, the electrical power for the wired input device could be supplied through the path established with the input connector 30F. Therefore, the input connector 30F of this present invention also has the function as a recharging connecting part by using the +/− source pins of the input connecting part 30F as the electrical source for an input device. When recharging an input device, one would connect the first output connector 30B or the second output connector 30C to the computer first for obtaining electrical power, followed by connecting the input connector 30F with the recharging ends of the input device, such as a wireless mouse or a wireless keyboard. Thus, the input device would be recharged.

The multi-output connector of the present invention enhances the function of a connector in the following aspects:
1. The multi-output connector of the present invention can be built to contain a first output connector and a second output connector of different types, according to a user's preference. It doesn't need any converter and can be directly connected to a corresponding jack of an electronic device. It provides unsurpassed convenience.
2. The multi-output connector has a built-in wireless receive circuit. Therefore it excels average connectors which have only connecting function.
3. The multi-output connector of the present invention possesses functions of wirelessly receiving data and multiple outputting. It is compact, light, and highly effective. Since the present invention embodies in one single component with converting function, it reduces greatly the manufacturing cost.
4. The multi-output connector of the present invention functions to recharge an input device, a figure next to none of the existing converter or pluggable electronic device.

Although the present invention has been illustrated and described with reference to the preferred embodiment thereof, it should be understood that it is in no way limited to the details of such embodiment but is capable of numerous modifications within the scope of the appended claims.

What is claimed is:

1. A multi-output connector capable of receiving data wirelessly, comprising:
a wireless receive circuit, which is placed inside the wireless input device and functions to receive data wirelessly;
at least one first output connecting part, which is electrically connected to said wireless receive circuit and functions as a connection path for outputting data;
at least one second output connecting part, which is electrically connected to said wireless receive circuit and functions as a connection path for outputting data.

2. The multi-output connector as in claim 1, wherein said first output connecting part is an USB connector, a PS2 connector, or an IEEE1394 connector.

3. The multi-output connector as in claim 1, wherein said second output connecting part is an USB connector, a PS2 connector, or an IEEE1394 connector.

4. The multi-output connector as in claim 1, wherein said wireless receive circuit is a Bluetooth wireless receive circuit.

5. The multi-output connector as in claim 1, wherein said data is emitted by a wireless mouse.

6. The multi-output connector as in claim 1, wherein said data is emitted by a wireless keyboard.

7. The multi-output connector as in claim 1, further comprising:
at least one third output connecting part which is electrically connected to said wireless receive circuit and functions as a connection path for outputting data.

8. The multi-output connector as in claim 1, wherein said third output connecting part is an USB connector, a PS2 connector, or an IEEE1394 connector.

9. The multi-output connector as in claim 1, further comprising:
an input connecting part which is connected to a wired input device.

10. The multi-output connector as in claim 9, wherein said input connecting part is also a recharging connecting part, which functions as the power source to recharge an input device through its positive/negative power pins.

11. The multi-output connector as in claim 9, wherein said input connecting part is an USB jack or a PS2 jack.

12. The multi-output connector as in claim 9, wherein said wired input device is a keyboard, a mouse, a tracking ball, or a joystick.
